(19) United States
(12) Patent Application Publication
(10) Pub. No.: US 2011/0119579 A1
(43) Pub. Date: May 19, 2011

(54) METHOD OF TURNING OVER THREE-DIMENSIONAL GRAPHIC OBJECT BY USE OF TOUCH SENSITIVE INPUT DEVICE

(75) Inventors: Chien-Yu Huang, Yongkang City (TW); Chin-Chin Chen, Zhonghe City (TW); Chih-Chieh Hsiao, Taichung City (TW)

(73) Assignee: QUANTA COMPUTER, INC., Tao Yuan Shien (TW)

(21) Appl. No.: 12/831,429

(22) Filed: Jul. 7, 2010

(30) Foreign Application Priority Data
Nov. 16, 2009 (TW) 098138759

(51) Int. Cl. G06F 3/01; G06F 3/048

(52) U.S. Cl. 715/702; 715/848; 715/863

(57) ABSTRACT

The invention provides a method of turning over a three-dimensional graphic object by use of a touch sensitive input device. In particular, the method according to the invention provides a user with intuitive operation on a touch sensitive surface of the touch sensitive input device to turn over whole or a portion (e.g., a page sub-object) of the three-dimensional graphic object.

### BACKGROUND OF THE INVENTION

1. Field of the Invention

The invention provides a method of turning over a three-dimensional graphic object displayed on a display device by use of a touch sensitive input device. In particular, the method according to the invention provides a user with intuitive operation on a touch sensitive surface of the touch sensitive input device to turn over whole or a portion (e.g., a page sub-object) of the three-dimensional graphic object.

2. Description of the Prior Art

Since touch screens have the advantage of enabling operators to intuitively input coordinate relative to the display device via touch method, touch screens have become popular input apparatuses equipped by modern display devices. Touch screens have been widely applied to various electronic products having display devices, such as monitors, laptop computers, tablet computers, automated teller machines (ATM), point of sale, tourist guiding systems, industrial control systems, mobile phones, and so on.

Besides conventional resistive-type and conductive-type touch screens with which operators have to input in direct contact, optical touch screens utilizing image capturing devices with which operators need not to directly contact the screen has also been widely adopted.

The generalized touch sensitive input devices have been into the field of multi-touch technology, which enables users to make gestures such as a zoom gesture, a pan gesture, a rotation gesture, etc., so as to more intuitively operate electronic products with touch sensitive input devices.

However, as to three-dimensional graphic objects, particularly three-dimensional graphic objects having page sub-objects such as books, monthly calendars, etc., there is presently no any technology of sensing intuitive gestures by use of touch sensitive input device to turn over whole or a portion (e.g., a page sub-object) of the three-dimensional graphic object.

Accordingly, a scope of the invention is to provide a method of turning over a three-dimensional graphic object by use of a touch sensitive input device which provides a user with intuitive operation on a touch sensitive surface of the touch sensitive input device to turn over whole or a portion (e.g., a page sub-object) of the three-dimensional graphic object.

### SUMMARY OF THE INVENTION

A method of turning over a three-dimensional graphic object displayed on a display device by use a touch sensitive input device according to a preferred embodiment of the invention, firstly, senses multiple touches on a touch sensitive surface of the touch sensitive input device at a sensing interval and a subsequent track relative to the sensed touches. Afterwards, the method according to the invention judges if the three-dimensional graphic object has a predetermined rotation axis. If the method according to the invention judges that the three-dimensional graphic object has a predetermined rotation axis, then the method goes on to judge if the sensed points and the track relative to the sensed touches meet a criterion. If the method judges that the criterion is met, then the method turns over whole or a portion of the three-dimensional graphic object around the predetermined rotation axis based on the criterion.

In an embodiment, the three-dimensional graphic object has a first page sub-object thereon defining an edge region. The criterion is that the sensed touches are identified as a grab gesture, a center of the sensed touches corresponds to the edge region of the first page sub-object and the track relative to the sensed touches is towards the predetermined rotation axis. If the criterion is met, then the method according to the invention turns over the first page sub-object around the predetermined rotation axis to show a second page sub-object previously beneath the first page sub-object.

In an embodiment, the criterion is that the sensed touches are identified as a grab gesture, a center of the sensed touched corresponds to the predetermined rotation axis and the track relative to the sensed touches is away from the predetermined rotation axis. If the criterion is met, then the method according to the invention turns over a third page sub-object of the three-dimensional graphic object at the side of the predetermined rotation axis opposite to a direction of the track around the predetermined axis to show a back of the third page sub-object.

In an embodiment, the criterion is that the sensed touches are identified as an area larger than a threshold, a center of the sensed touches corresponds to the three-dimensional graphical object and the track relative to the sensed touches is towards the predetermined rotation axis. If the criterion is met, the method according to the invention turns over the three-dimensional graphic object around the predetermined rotation axis counterclockwise.

In an embodiment, the criterion is that the sensed touches are identified as an area larger than a threshold, a center of the sensed touches corresponds to the three-dimensional graphical object and the track relative to the sensed touches is away from the predetermined rotation axis. If the criterion is met, then the method according to the invention turns over the three-dimensional graphic object around the predetermined rotation axis clockwise.

According to another preferred embodiment of the invention, if the method of turning over a three-dimensional graphic object displayed on a display device judges that the three-dimensional graphical object does not have a predetermined rotation axis, then the method further judges if an area identified from the sensed touches is larger than a threshold and a center of the sensed touches corresponds to the three-dimensional graphic object. If the method judges that the area is larger than the threshold and the center corresponds to the three-dimensional graphic object, then the method determines a temporary rotation axis in accordance with the track relative to the sensed touches and a center of gravity of the three-dimensional graphic object, and turns over whole of the three-dimensional graphic object around the temporary rotation axis in accordance with the track relative to the sensed touches. In an embodiment, the temporary rotation axis is determined as an axis passing through the center of gravity of the three-dimensional graphic object and being perpendicular to the track relative to the sensed touches.

The advantage and spirit of the invention may be understood by the following recitations together with the appended drawings.

### BRIEF DESCRIPTION OF THE APPENDED DRAWINGS

FIG. 1 is a flow chart of a method of turning over a three-dimensional graphic object displayed on a display device according to a preferred embodiment of the invention.

FIG. 2A through FIG. 2H schematically show the process of turning over a monthly calendar-shaped three-dimensional graphical object using a method according to the invention.

FIG. 3A through FIG. 3C schematically show the process of turning over a book-shaped three-dimensional graphical object using a method according to the invention.

FIG. 4A through FIG. 4B schematically show the process of turning over a three-dimensional graphical object without a predetermined rotation axis displayed on a display device using a method according to the invention.

### DETAILED DESCRIPTION OF THE INVENTION

The invention provides a method of turning over a three-dimensional graphic object displayed on a display device by use of a touch sensitive input device. Accordingly, the method according to the invention provides a user with intuitive operation on a touch sensitive surface of the touch sensitive input device to turn over whole or a portion of the three-dimensional graphic object, such as whole or a page of a book-shaped three-dimensional graphical object. With following detailed explanations of the preferred embodiments of the invention, the features, spirits, advantages, and feasibility of the invention will be hopefully well described.

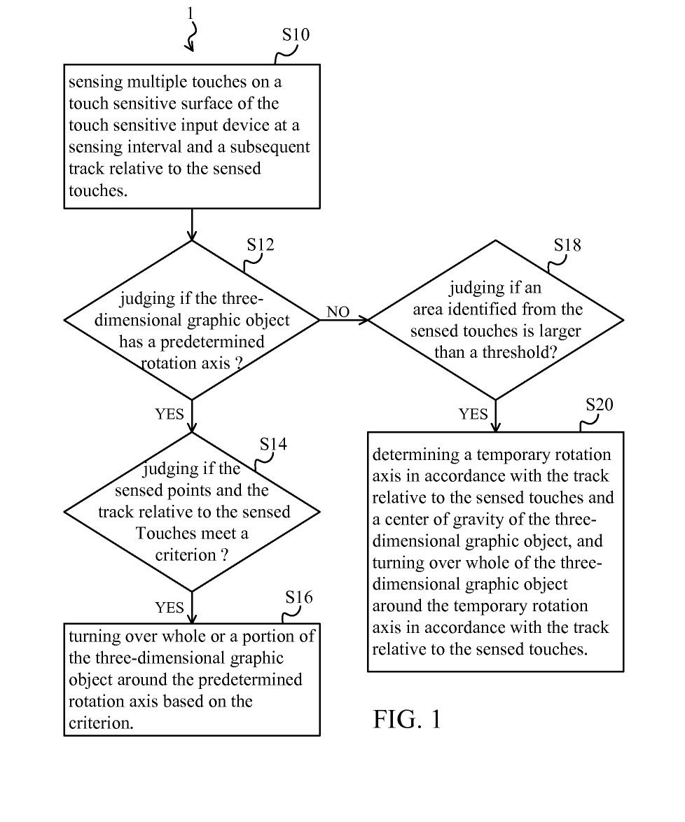

Please refer to FIG. 1. FIG. 1 is a flow chart of a method 1 of turning over a three-dimensional graphic object displayed on a display device according to a preferred embodiment of the invention. The method 1 according to the invention uses a touch sensitive input device (e.g., a resistive-type touch screen, a conductive-type touch screen, an optical touch screen, and so on) to turn over a three-dimensional graphic object displayed on a display device.

As shown in FIG. 1, the method 1 of turning over a three-dimensional graphic object according to the invention, firstly, performs step S10 to sense multiple touches on a touch sensitive surface of the touch sensitive input device at a sensing interval and a subsequent track relative to the sensed touches.

Afterwards, the method 1 of turning over a three-dimensional graphic object according to the invention performs step S12 to judge if the three-dimensional graphic object has a predetermined rotation axis.

If the result judged in step S12 is YES, then the method 1 of turning over a three-dimensional graphic object according to the invention performs step S14 to judge if the sensed points and the track relative to the sensed touches meet a criterion. If the result judged in step S14 is YES, the method 1 of turning over a three-dimensional graphic object according to the invention performs step S16 to turn over whole or a portion of the three-dimensional graphic object around the predetermined rotation axis based on the criterion.

In an embodiment, the three-dimensional graphic object has a first page sub-object and the criterion is that the sensed touches are identified as a grab gesture, a center of the sensed touches corresponds to the edge region and the track relative to the sensed touches is towards the predetermined rotation axis. If the criterion is met, then the method 1 according to the invention turns over the first page sub-object around the predetermined rotation axis to show a second page sub-object previously beneath the first page sub-object. In practice, the sensed touches are identified as a grab gesture if the sensed touches at the sensing interval are close to each other by analysis.

In an embodiment, the criterion is that the sensed touches are identified as a grab gesture, a center of the sensed touched corresponds to the predetermined rotation axis and the track relative to the sensed touches is away from the predetermined rotation axis. If the criterion is met, then the method 1 according to the invention turns over a third page sub-object of the three-dimensional graphic object at the side of the predetermined rotation axis opposite to a direction of the track around the predetermined axis to show a back of the third page sub-object. In practice, the sensed touches are identified as a grab gesture if the sensed touches at the sensing interval are close to each other by analysis.

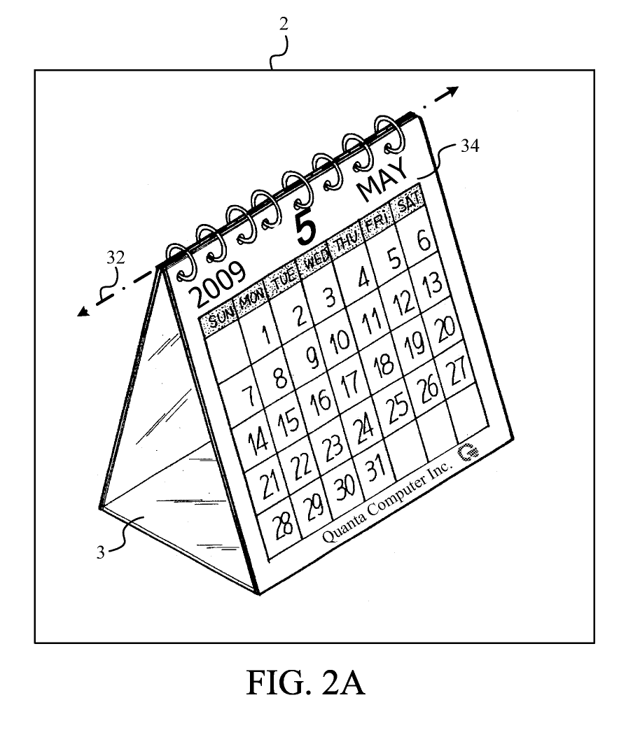

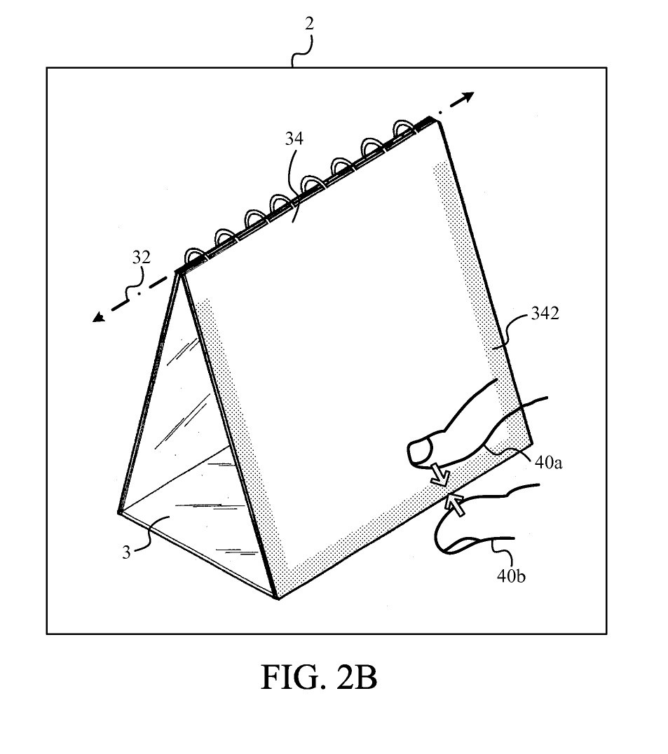

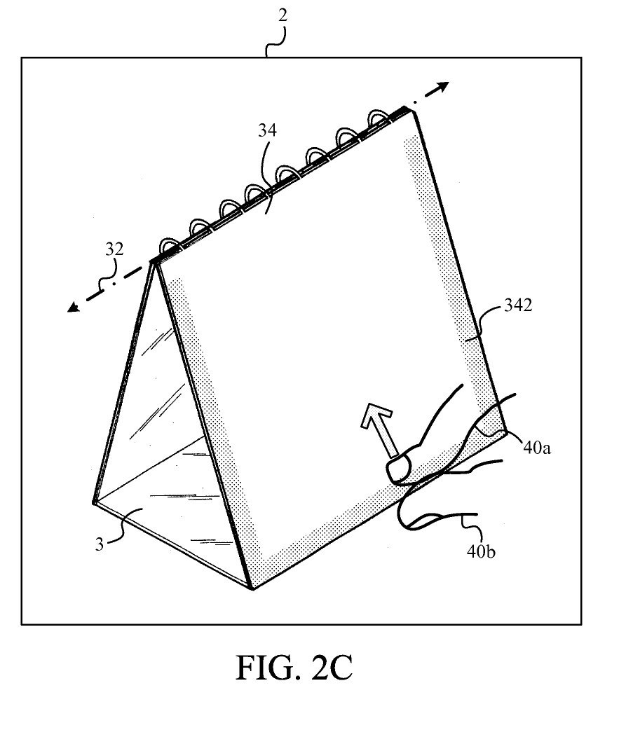

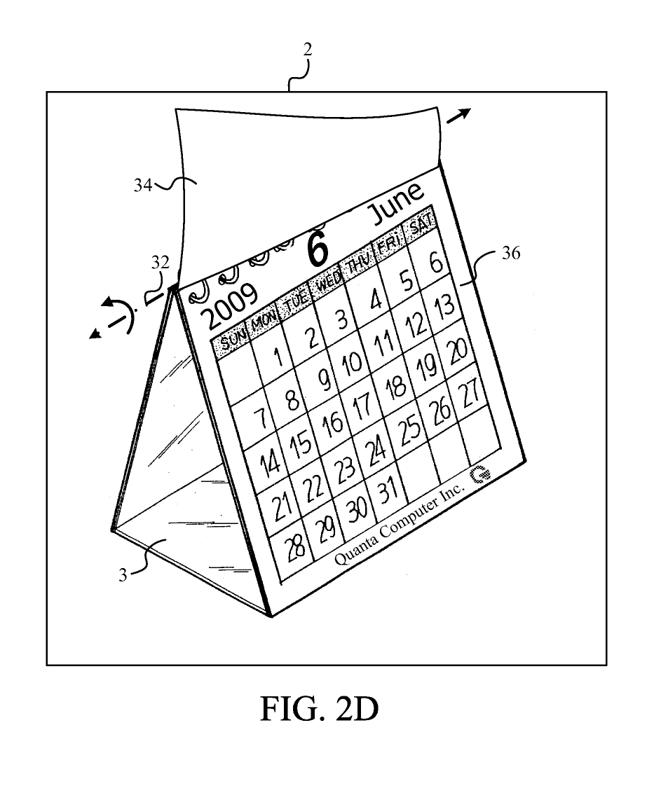

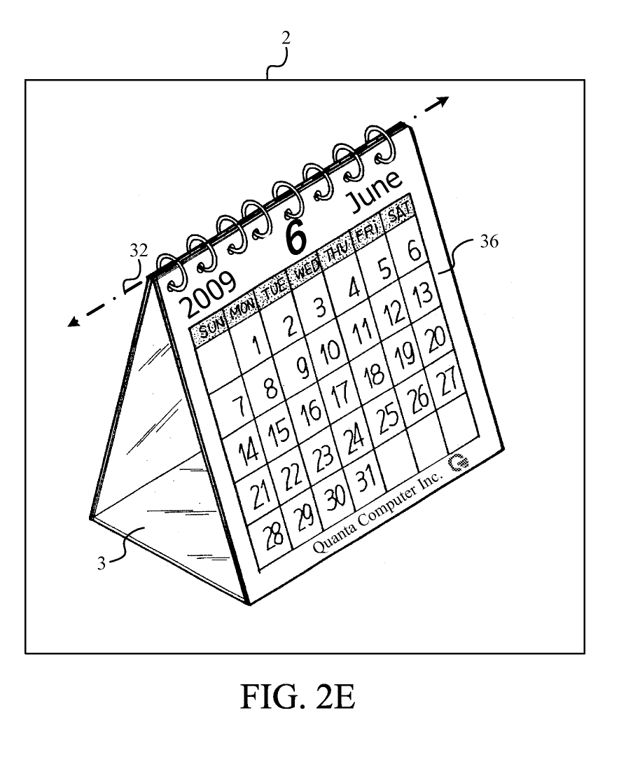

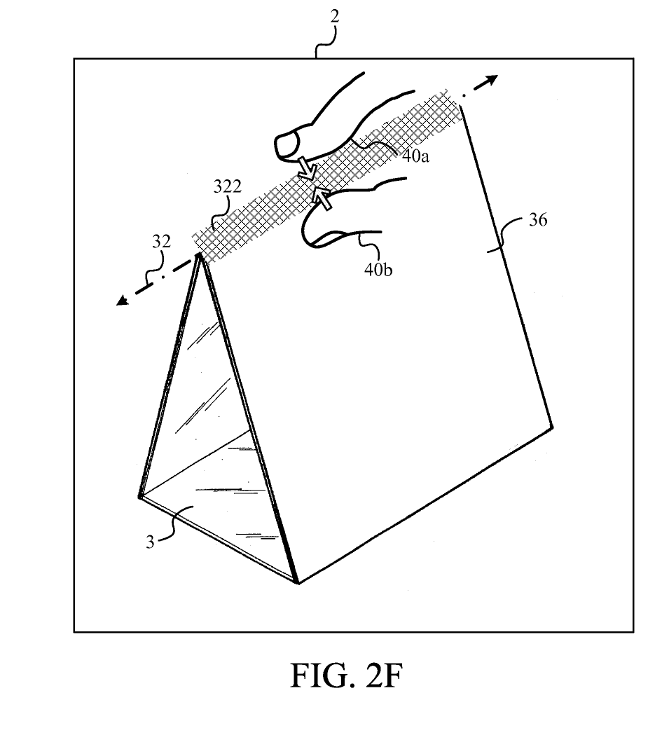

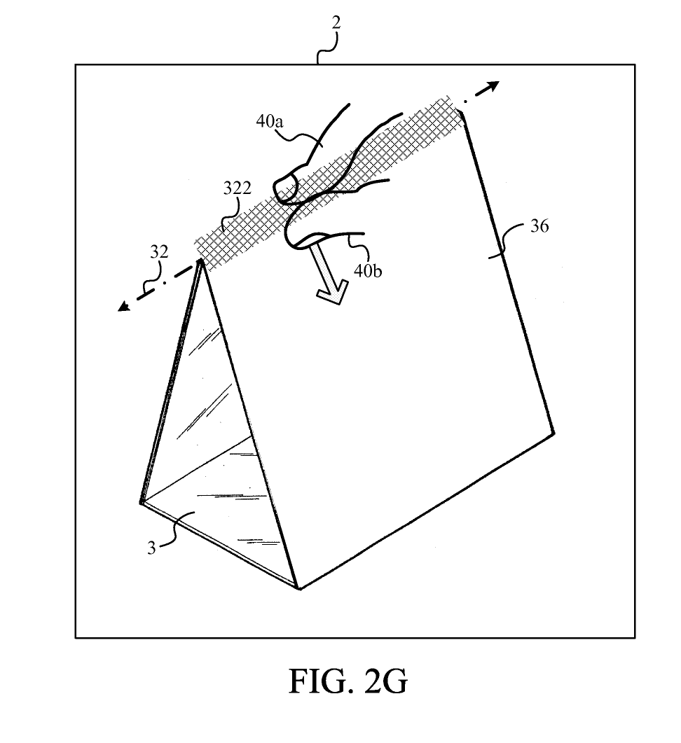

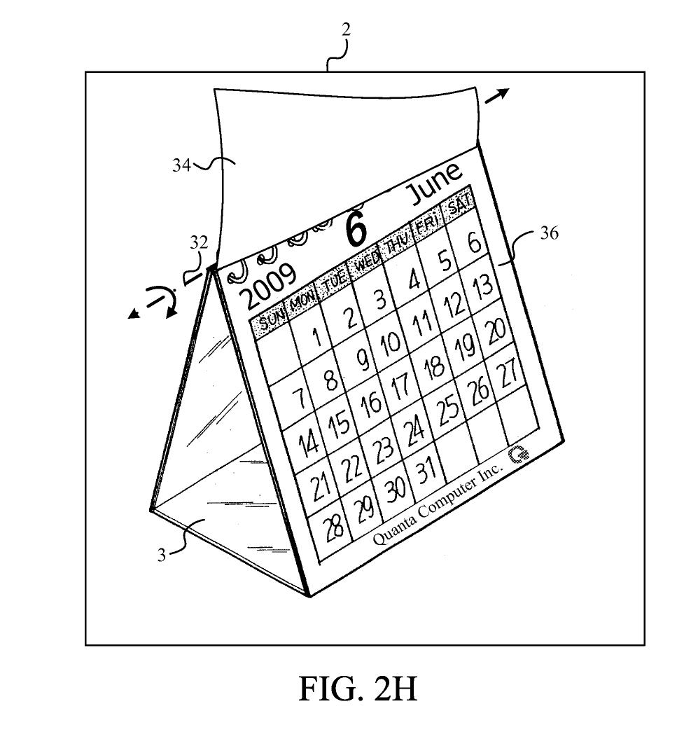

Please refer to FIG. 2A through FIG. 2H. FIG. 2A through FIG. 2H schematically show the process of turning over a monthly calendar-shaped three-dimensional graphical object 3 using a method 1 according to the invention.

As shown in FIG. 2A, the monthly calendar-shaped three-dimensional graphical object 3 has a first page sub-object 34 as the MAY monthly calendar page. And the monthly calendar-shaped three-dimensional graphical object 3 has a predetermined rotation axis 32.

As shown in FIG. 2B, the first page sub-object 34 thereon defines an edge region 342 as being the screentone-patterned region 342. For clear illustration, FIG. 2B shows only the screentone-patterned region 342 schematically on the first page sub-object 34 without content of the MAY monthly calendar page.

As well as shown in FIG. 2B, two fingers (40a, 40b) are sensed as multiple touches on a touch sensitive surface (not shown in FIG. 2B), and a center of the sensed touches corresponds to the edge region 342 of the first page sub-object 34. Sensed touches can also be other objects sensed on the touch sensitive surface, such as a stylus. Since the fingers (40a, 40b) at the sensing interval are close to each other, the sensed touches are identified as a grab gesture by analysis.

As shown in FIG. 2C, a subsequent track relative to the sensed touches of the two fingers (40a, 40b) on the touch sensitive surface is towards the predetermined rotation axis 32. Therefore, the operation of the fingers (40a, 40b) on the touch sensitive surface meets a criterion of turning over the first page sub-object 34 backward. Then, as shown in FIG. 2D, the method 1 according to the invention turns over the first page sub-object 34 around the predetermined rotation axis 32 backward. Finally, as shown in FIG. 2D, a second page sub-object 36 previously beneath the first page sub-object 34 is shown as being the JUNE monthly calendar page shown in FIG. 2E.

As shown in FIG. 2F, a display device 2 displays a second page sub-object 36 of the monthly calendar-shaped three-dimensional graphical object 3. For clear illustration, FIG. 2F does not show the content of the JUNE monthly calendar page. FIG. 2F shows a region 322 corresponding to the predetermined rotation axis 32, namely the screentone-patterned region 322.

As well as shown in FIG. 2F, two fingers (40a, 40b) are sensed as multiple touches on the touch sensitive surface, and a center of the sensed touches corresponds to the region 322 corresponding to the predetermined rotation axis 32. And since the fingers (40a, 40b) at the sensing interval are close to each other, the sensed touches are identified as a grab gesture by analysis.

As shown in FIG. 2G, a subsequent track relative to the sensed touches of the two fingers (40a, 40b) on the touch sensitive surface is away from the predetermined rotation axis. Therefore, the operation of the fingers (40a, 40b) on the touch sensitive surface meets a criterion of turning over a page sub-object at the back side of the monthly calendar-shaped graphic object 3 forward. Then, as shown in FIG. 2H, the method 1 according to the invention turns over the first page sub-object 34 forward around the predetermined rotation axis 32. Finally, the first page sub-object 34 is shown again as the MAY monthly calendar page shown in FIG. 2A.

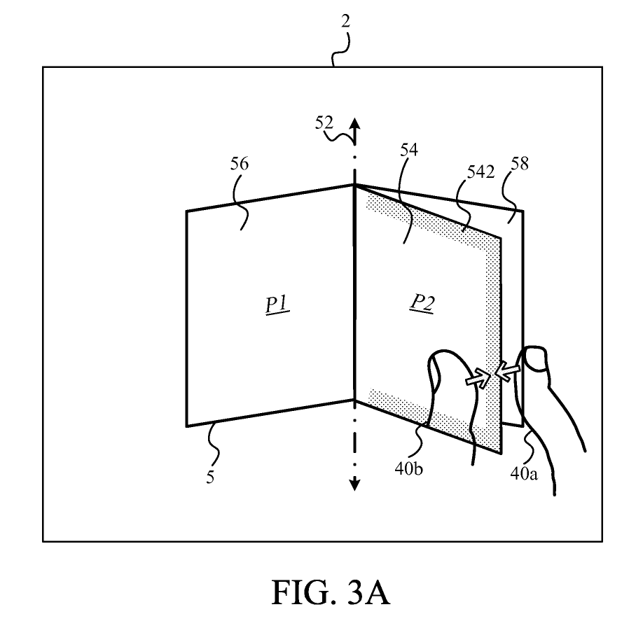

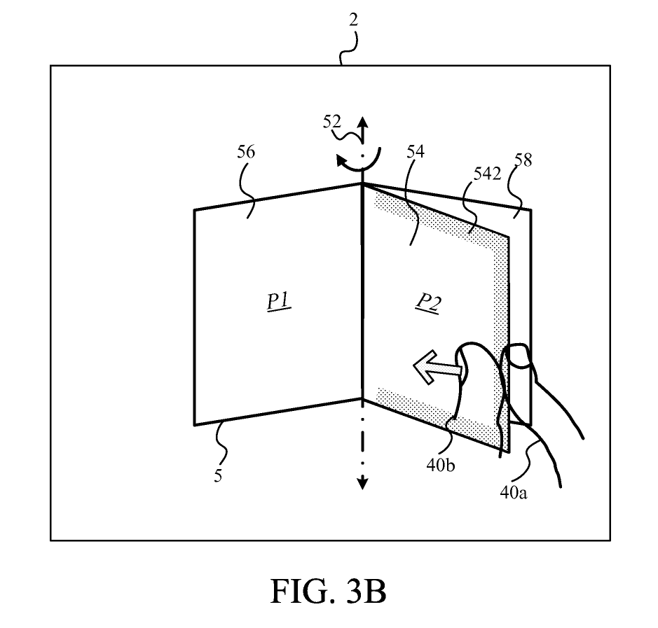

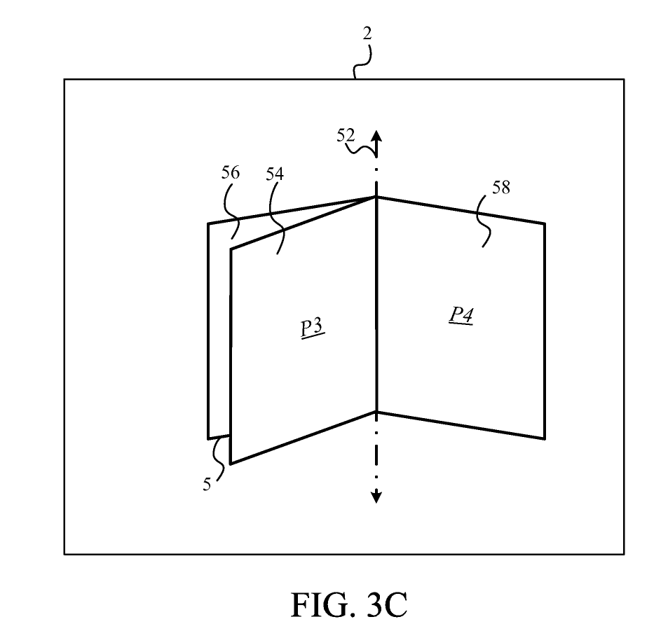

Please refer to FIG. 3A through FIG. 3C. FIG. 3A through FIG. 3C schematically show the process of turning over a book-shaped three-dimensional graphical object 5 displayed on a display device 2 using a method 1 according to the invention.

As shown in FIG. 3A, the book-shaped three-dimensional graphical object 5 has a predetermined rotation axis 52. And the book-shaped three-dimensional graphical object 5 has a first page sub-object 54, a second page sub-object 56 and a third page sub-object 58.

As well as shown in FIG. 3A, the first page sub-object 54 thereon defines an edge region 542 as being the screentone-patterned region 542. Two fingers (40a, 40b) are sensed as multiple touches on a touch sensitive surface (not shown in FIG. 3A), and a center of the sensed touches corresponds to the edge region 542 of the first page sub-object 54. Sensed touches can also be other objects sensed on the touch sensitive surface, such as a stylus. Since the fingers (40a, 40b) at the sensing interval are close to each other, the sensed touches are identified as a grab gesture by analysis.

As shown in FIG. 3B, a subsequent track relative to the sensed touches of the two fingers (40a, 40b) on the touch sensitive surface is towards the predetermined rotation axis 52. Therefore, the operation of the fingers (40a, 40b) on the touch sensitive surface meets a criterion of turning over the first page sub-object 54 left. Then, the method 1 according to the invention turns over the first page sub-object 54 left around the predetermined rotation axis 52. Finally, as shown in FIG. 3C, the first page sub-object 54 is turned over to the left side of the predetermined rotation axis 52, and a third page sub-object 58 previously beneath the first page sub-object 54 is shown.

In an embodiment, the criterion is that the sensed touches are identified as a grab gesture, a center of the sensed touched corresponds to the predetermined rotation axis and the track relative to the sensed touches is away from the predetermined rotation axis. If the criterion is met, then the method according to the invention turns over a third page sub-object of the three-dimensional graphic object at the side of the predetermined rotation axis opposite to a direction of the track around the predetermined axis to show a back of the third page sub-object. Take the book-shaped three-dimensional graphical object 5 shown in FIG. 3A for instance again. On the touch sensitive surface, a grab gesture can be operated on the predetermined rotation axis 52 of the book-shaped three-dimensional graphical object 5. Then, if the subsequent track of the grab gesture is towards the right of the predetermined rotation axis 52, the page sub-object at the left side of the predetermined rotation axis 52 will be turned over towards the right of the predetermined rotation axis 52; if the subsequent track of the grab gesture is towards the left of the predetermined rotation axis 52, the page sub-object at the right side of the predetermined rotation axis 52 will be turned over towards the left of the predetermined rotation axis 52.

In an embodiment, the criterion is that the sensed touches are identified as an area larger than a threshold, a center of the sensed touches corresponds to the three-dimensional graphical object and the track relative to the sensed touches is towards the predetermined rotation axis. If the criterion is met, the method according to the invention turns over the three-dimensional graphic object around the predetermined rotation axis counterclockwise.

In an embodiment, the criterion is that the sensed touches are identified as an area larger than a threshold, a center of the sensed touches corresponds to three-dimensional graphical object and the track relative to the sensed touches is away from the predetermined rotation axis. If the criterion is met, then the method according to the invention turns over the three-dimensional graphic object around the predetermined rotation axis clockwise.

As well as shown in FIG. 1, if the result judged in step S12 is NO, a method 1 of turning over a three-dimensional graphic object according to another preferred embodiment of the invention further performs step S18 to judge if an area identified from the sensed touches is larger than a threshold and a center of the sensed touches corresponds to the three-dimensional graphic object.

If the result judged in step S18 is YES, the method 1 of turning over a three-dimensional graphic object according to the invention then performs step S20 to determine a temporary rotation axis in accordance with the track relative to the sensed touches and a center of gravity of the three-dimensional graphic object, and turns over whole of the three-dimensional graphic object around the temporary rotation axis in accordance with the track relative to the sensed touches.

In an embodiment, the temporary rotation axis is determined as an axis passing through the center of gravity of the three-dimensional graphic object and being perpendicular to the track relative to the sensed touches.

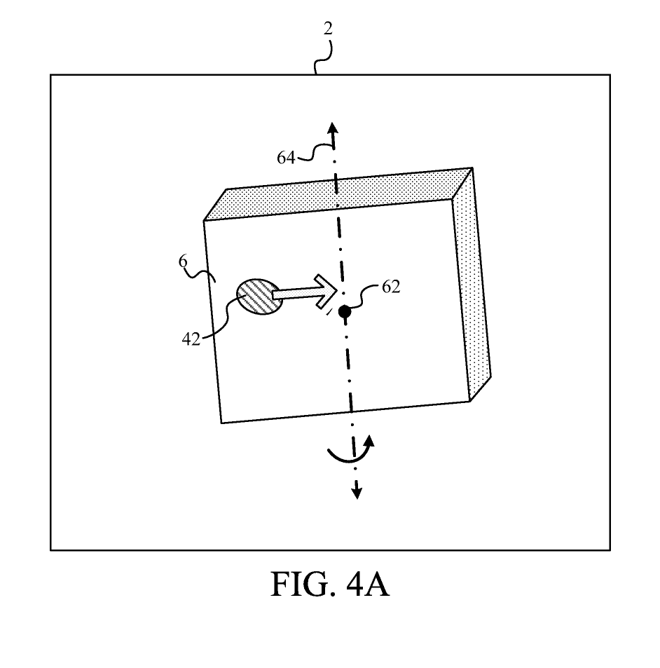

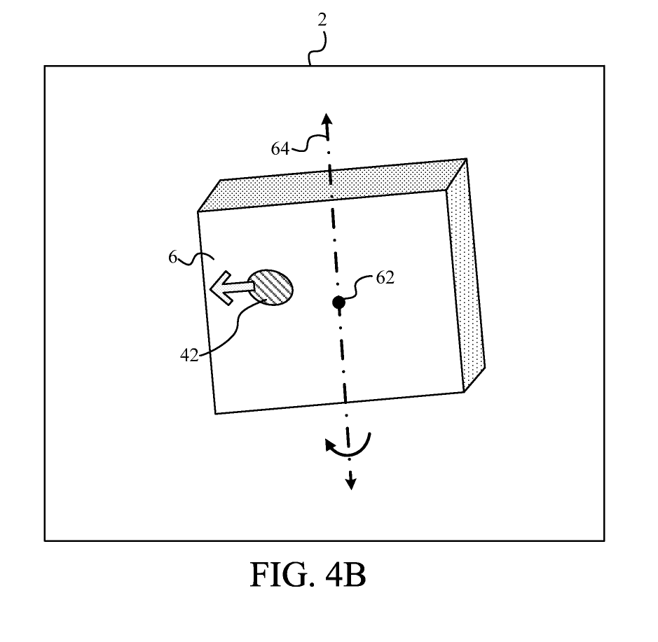

Please refer to FIG. 4A through FIG. 4B. FIG. 4A through FIG. 4B schematically show the process of turning over a three-dimensional graphical object 6 without a predetermined rotation axis displayed on a display device 2 using a method 1 according to the invention.

As shown in FIG. 4A, the three-dimensional graphical object 6 has a center of gravity 62. Sensed touches of multiple fingers on the touch sensitive surface (not shown in FIG. 4A) are identified as an area 42 larger than a threshold, and a center of the sensed touches corresponds to the three-dimensional graphical object 6.

As well as shown in FIG. 4A, an axis 64 passing through the center of gravity 62 of the three-dimensional graphic object 6 and being perpendicular to the track relative to the sensed touches is determined as the temporary rotation axis. Since the operation of the multiple fingers on the touch sensitive surface meets the criterion of turning over and the track relative to the sensed touches is towards the temporary axis 64, whole of the three-dimensional graphic object 6 is turned over around the temporary rotation axis 64 counterclockwise, as shown in FIG. 4A.

As shown in FIG. 4B, the three-dimensional graphical object 6 has a center of gravity 62. Sensed touches of multiple fingers on the touch sensitive surface (not shown in FIG. 4A) are identified as an area 42 larger than a threshold, and a center of the sensed touches corresponds to the three-dimensional graphical object 6. An axis 64 passing through the center of gravity 62 of the three-dimensional graphic object 6 and being perpendicular to the track relative to the sensed touches is determined as the temporary rotation axis. Since the operation of the multiple fingers on the touch sensitive surface meets the criterion of turning over and the track relative to the sensed touches is away from the temporary axis 64, whole of the three-dimensional graphic object 6 is turned over around the temporary rotation axis 64 clockwise, as shown in FIG. 4B.

With above explanation, it is understood that the method of turning over a three-dimensional graphic object displayed on a display device by use of a touch sensitive input device according to the invention provides a user with intuitive operation on a touch sensitive surface of the touch sensitive input device to turn over whole or a single page sub-object of the three-dimensional graphic object, such as a monthly calendar, a book, and so on.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method of turning over a three-dimensional graphic object by use a touch sensitive input device, said method comprising the steps of:
(a) sensing multiple touches on a touch sensitive surface of the touch sensitive input device at a sensing interval and a subsequent track relative to the sensed touches;
(b) judging if the three-dimensional graphic object has a predetermined rotation axis; and
(c) if YES in step (b), judging if the sensed points and the track relative to the sensed touches meet a criterion, and if YES, turning over whole or a portion of the three-dimensional graphic object around the predetermined rotation axis based on the criterion.

2. The method of claim 1, wherein the three-dimensional graphic object has a first page sub-object thereon defining an edge region, in step (b), the criterion is that the sensed touches are identified as a grab gesture, a center of the sensed touches corresponds to the edge region and the track relative to the sensed touches is towards the predetermined rotation axis, in step (c), the first page sub-object is turned over around the predetermined rotation axis to show a second page sub-object previously beneath the first page sub-object.

3. The method of claim 2, wherein the sensed touches are identified as a grab gesture if the sensed touches at the sensing interval are close to each other by analysis.

4. The method of claim 1, wherein in step (b), the criterion is that the sensed touches are identified as a grab gesture, a center of the sensed touched corresponds to the predetermined rotation axis and the track relative to the sensed touches is away from the predetermined rotation axis, and in step (c), a third page sub-object of the three-dimensional graphic object at the side of the predetermined rotation axis opposite to a direction of the track is turned over around the predetermined axis to show a back of the third page sub-object.

5. The method of claim 4, wherein the sensed touches are identified as a grab gesture if the sensed touches at the sensing interval are close to each other by analysis.

6. The method of claim 1, wherein in step (b), the criterion is that the sensed touches are identified as an area larger than a threshold, a center of the sensed touches corresponds to the three-dimensional graphical object and the track relative to the sensed touches is towards the predetermined rotation axis, and in step (c), the three-dimensional graphic object is turned over around the predetermined rotation axis counterclockwise.

7. The method of claim 1, wherein in step (b), the criterion is that the sensed touches are identified as an area larger than a threshold a center of the sensed touches corresponds to the three-dimensional graphical object and the track relative to the sensed touches is away from the predetermined rotation axis, and in step (c), the three-dimensional graphic object is turned over around the predetermined rotation axis clockwise.

8. The method of claim 1, further comprising the steps of:
(d) if NO in step (b), judging if an area identified from the sensed touches is larger than a threshold and a center of the sensed touches corresponds to the three-dimensional graphic object, and if YES, determining a temporary rotation axis in accordance with the track relative to the sensed touches and a center of gravity of the three-dimensional graphic object, and turning over whole of the three-dimensional graphic object around the temporary rotation axis in accordance with the track relative to the sensed touches.

9. The method of claim 8, wherein in step (d), the temporary rotation axis is determined as an axis passing through the center of gravity of the three-dimensional graphic object and being perpendicular to the track relative to the sensed touches.

10. The method of claim 9, wherein in step (d), if the track relative to the sensed touches is towards the temporary rotation axis, the three-dimensional graphic object is turned over around the temporary rotation axis counterclockwise.

11. The method of claim 9, wherein in step (d), if the track relative to the sensed touches is away from the temporary rotation axis, the three-dimensional graphic object is turned over around the temporary rotation axis clockwise.
